(19) United States
(12) Patent Application Publication
(10) Pub. No.: US 2023/0123149 A1
(43) Pub. Date: Apr. 20, 2023

(54) TOP COVER ASSEMBLY AND BATTERY

(71) Applicant: Xiamen Hithium Energy Storage Technology Co., Ltd., Xiamen (CN)

(72) Inventors: Weidong XU, Xiamen (CN); Nan ZHANG, Xiamen (CN); Yang TANG, Xiamen (CN); Ziqi YI, Xiamen (CN); Zuyu WU, Xiamen (CN)

(73) Assignee: Xiamen Hithium Energy Storage Technology Co., Ltd., Xiamen (CN)

(21) Appl. No.: 17/956,245

(22) Filed: Sep. 29, 2022

(30) Foreign Application Priority Data
Oct. 18, 2021 (CN) 202122506604.1

(51) Int. Cl. H01M 50/143; H01M 50/166

(52) U.S. Cl. CPC H01M 50/143; H01M 50/166

(57) ABSTRACT

The present disclosure discloses a top cover assembly and a battery. The top cover assembly comprises a top cover plate and an explosion-proof sheet. The explosion-proof sheet is configured for being connected to the top cover plate to close an explosion-proof hole formed in the top cover plate, and the explosion-proof sheet comprises: a connecting portion, a body portion, a weak portion and a reinforced portion, the connecting portion is configured for being connected to the top cover plate, the body portion is connected to the connecting portion and configured for closing the explosion-proof hole corresponding to the explosion-proof hole, the weak portion is located between the body portion and the connecting portion, the reinforced portion is convexly arranged on the body portion, along thickness direction of the explosion-proof sheet, the thickness of the reinforced portion is h1, the thickness of the body portion is h2, and 1<(h1+h2)/h2≤2.8.

### FIELD

The present disclosure relates to the field of batteries, and in particular, to a top cover assembly and a battery.

### BACKGROUND

At present, there are usually explosion-proof holes in the top cover of the battery, and the explosion-proof plate is set at the explosion-proof hole, so that when the pressure inside the battery exceeds the threshold value, the explosion-proof plate can be automatically damaged by excessive pressure, so that the inside of the battery is connected to the outside through the explosion-proof hole, thus releasing the high temperature and high pressure gas inside the battery, thus avoiding the explosion of the battery and ensuring the safety of the use of the battery.

However, in the actual use process, there is often a problem that the cracking accuracy of the explosion-proof sheet is not high, resulting in premature cracking of the explosion-proof sheet when the air pressure inside the battery has not yet reached the threshold, affecting the safety of the battery, or cracking only when the air pressure inside the battery far exceeds the threshold, resulting in poor safety in the use of the battery. And, in the process of daily use, the air pressure inside the battery will change with the temperature of the environment in which the battery is located, the explosion-proof sheet is constantly deformed under the action of different pressures, so that the structure of the explosion-proof sheet is easily aged and fragile due to repeated deformations. As a result, before the air pressure inside the battery reaches the threshold value, the explosion-proof sheet cannot withstand the pressure and break, thus affecting the safety of the use of the battery and affecting the normal service life of the battery.

### SUMMARY

The embodiments of the present disclosure disclose a top cover assembly and a battery, which can effectively mitigate the deformation effect of the explosion-proof sheet under different pressure effects, and reduce the aging probability of the explosion-proof sheet.

To achieve the above objective, in a first aspect, the present disclosure discloses a top cover assembly, comprising:

a top cover plate, wherein an explosion-proof hole is formed in the top cover plate; and

an explosion-proof sheet, wherein the explosion-proof sheet is configured to be connected to the top cover plate to close the explosion-proof hole, and the explosion-proof sheet comprises:

a connecting portion, wherein the connecting portion is configured to be connected to the top cover plate;

a body portion, the body portion being connected to the connecting portion and being configured to be disposed in the explosion-proof hole to close the explosion-proof hole, the body portion being provided with at least one reinforced portion; and

a weak portion, the weak portion being located between the body portion and the connecting portion;

wherein along a thickness direction of the explosion-proof sheet, a thickness of the reinforced portion is h1, a thickness of the body portion is h2, and 1<(h1+h2)/h2≤2.8.

In an optional embodiment, 0.3 mm≤(h1+h2)≤1.7 mm.

In an optional embodiment, at least one outer surface of the reinforced portion is an inclined surface or an arc surface, such that the reinforced portion has a width gradually increasing from a top portion of the reinforced portion toward the body portion, a width of a side of the reinforced portion connected to the body portion is d, and d≤0.7 mm.

In an optional embodiment, in the thickness direction of the explosion-proof sheet, a projection area of the body portion is S1, a projection area of the reinforced portion is S2, and 5≤S1/S2≤10.

In an optional embodiment, the reinforced portion is a convex ridge extending along one or more arc-shaped trajectories or along one or more straight line trajectories.

In an optional embodiment, the reinforced portion is a C-shaped convex ridge;

when the body portion is provided with a plurality of the reinforced portions, at least two reinforced portions are symmetrically arranged relative to a center of the body portion, and when at least two adjacent reinforced portions are connected, the two adjacent reinforced portions are connected at their middle to form a middle connecting portion, and the middle connecting portion is located in the middle of the body portion;

in the thickness direction of the explosion-proof sheet, a projection area of the body portion is 51, a projection area of the middle connecting portion is S3, and 80≤S1/S3≤600.

In the extending direction of the reinforced portion, the reinforced portion has two end portions, and at least one end portion of the reinforced portion extends to be connected to the weak portion.

In an optional embodiment, in the extending direction of the reinforced portion, the reinforced portion has two end portions, and at least one end portion of the reinforced portion extends to be connected to the weak portion.

In an optional embodiment, the weak portion comprises a first portion and a second portion connected to each other, along the thickness direction of the explosion-proof sheet, a minimum thickness of the first portion is h3, a minimum thickness of the second portion is h4, and h2>h3>h4;

at least one end portion of the reinforced portion extends to be connected to a connection of the first portion and the second portion, or at least one end portion of the reinforced portion extends to be connected to the first portion.

In an optional embodiment, the weak portion is a racetrack-shaped structure, the racetrack-shaped structure comprises two straight line segments and two arc-shaped segments, the two straight line segments are parallel to each other, and the two arc-shaped segments are respectively connected to both ends of the two straight line segments;

the straight line segments are formed as the first portion, and the arc-shaped segments are formed as the second portion.

In a second aspect, the present disclosure discloses a battery, comprising a housing and a top cover assembly according to the first aspect, wherein the housing is provided with an accommodating cavity having an opening, and the top cover assembly is connected to the housing to cover the opening of the accommodating cavity.

Compared with the prior art, the present disclosure has the following beneficial effects:

According to the battery provided by the embodiments of the present disclosure, an explosion-proof hole is formed in the top cover plate, and the explosion-proof sheet is connected to the top cover plate to close the explosion-proof hole. The explosion-proof sheet includes a weak portion connected between the connecting portion and the body portion, so that when the pressure on the explosion-proof sheet is too large (that is, when the air pressure in the accommodating cavity of the housing exceeds a threshold value), the weak portion can generate cracking so that the high-temperature, high-pressure gas inside the housing can be discharged in a timely manner, and the cracking process of the explosion-proof sheet is controllable, and the intensity of the cracking process of the explosion-proof sheet is reduced, so as to reduce the impact generated when the explosion-proof sheet is damaged. At the same time, by arranging the reinforced portion at the body portion, the structural strength of the body portion can be improved to reduce the overall deformation of the body portion and the reinforced portion when the explosion-proof sheet is subjected to an external force, thereby reducing the overall deformation of the explosion-proof sheet, so that the weak portion is not prone to aging, thereby preventing the weak portion from premature cracking when the pressure borne by the weak portion does not reach the threshold value, thereby prolonging the service life of the battery.

In addition, the thickness h1 of the reinforced portion and the thickness h2 of the body portion satisfy: 1<(h1+h2)/h2<=2.8, so that the reinforced portion can locally thicken the body portion to improve the overall structural strength of the body portion. Meanwhile, the overall thickness of the body portion and the reinforced portion is not too thick, so that the structural strength of the explosion-proof sheet is not too strong, thus ensuring a high cracking precision of the explosion-proof sheet, that is, ensuring that the explosion-proof sheet can crack when the pressure borne by the explosion-proof sheet reaches a threshold range, and the explosion-proof sheet has a good effect of improving the safety of the battery.

### BRIEF DESCRIPTION OF THE DRAWINGS

To illustrate the technical solutions in the embodiments of the present disclosure more clearly, the drawings required in the embodiments will be briefly described below. It is apparent that the drawings in the following description are merely some of the embodiments of the present disclosure. For those of ordinary skill in the art, other drawings can be obtained according to these drawings without creative efforts.

FIG. 1 is a schematic structural view of a top cover assembly according to a first aspect of the present disclosure;

FIG. 2 is a schematic structural exploded view of a top cover assembly according to a first aspect of the present disclosure;

FIG. 3 is a partial cross-sectional view of a top cover assembly according to the first aspect of the present disclosure;

FIG. 4 is another partial cross-sectional view of the top cover assembly according to the first aspect of the present disclosure;

FIG. 5 is a schematic structural view of an explosion-proof sheet according to the first aspect of the present disclosure;

FIG. 6 is a cross-sectional view taken along line A-A in FIG. 5;

FIG. 7 is a cross-sectional view taken along line B-B in FIG. 5;

FIG. 8 is another three schematic structural views of an explosion-proof sheet according to the first aspect of the present disclosure;

FIG. 9 is a partial cross-sectional view of an explosion-proof sheet according to the first aspect of the present disclosure;

FIG. 10 is a schematic structural view of a battery according to a second aspect of the present disclosure; and

FIG. 11 is a schematic structural exploded view of a battery according to the second aspect of the present disclosure.

### REFERENCE NUMERALS

1, top cap assembly; 10, top cover plate; 100, explosion-proof hole; 100 a, first step surface; 100 b, second step surface; 11, explosion-proof sheet; 110, connecting portion; 111, body portion; 111a, first surface; 111b, second surface; 112, weak portion; 112a, first portion; 112b, second portion; 113, reinforced portion; 113a, end portion; 113b, first reinforced portion; 113c, second reinforced portion; 113d, third reinforced portion; 113e, middle connecting portion; uhf, opening; 113g, top portion; 12, explosion-proof valve patch; 140, straight line segment; 141, arc-shaped segment; 2, battery; 20, housing; 200, accommodating cavity; 201, opening; 21, battery cell.

### DETAILED DESCRIPTION OF EMBODIMENTS

The technical solutions in the embodiments of the present disclosure will be clearly and completely described below with reference to the drawings in the embodiments of the present disclosure. It is apparent that the described embodiments are merely a part of the embodiments of the present disclosure, rather than all of the embodiments. Based on the embodiments in the present disclosure, all other embodiments obtained by those of ordinary skill in the art without creative efforts shall fall within the protection scope of the present disclosure.

In the present disclosure, the terms “upper”, “lower”, “left”, “right”, “front”, “rear”, “top”, “bottom”, “inner”, “outer”, “middle”, “vertical”, “horizontal”, “transverse”, “longitudinal”, etc. indicate the orientation or position relationship based on the orientation or positional relationship shown in the drawings. These terms are primarily used to better describe the present disclosure and the embodiments thereof, and are not intended to limit the fact that the indicated device, element, or component must have a particular orientation, or be constructed and operated in a particular orientation.

In addition, some of the above terms may be used to express other meanings besides orientation or positional relationship, for example, the term “on” may also be used to express a certain attachment or connection relationship in some cases. For those of ordinary skill in the art, the specific meanings of these terms in the present disclosure can be understood on a case-by-case basis.

In addition, the terms “installed”, “arranged”, “provided”, “connected”, “joined” should be construed broadly. For example, it may be a fixed connection, a detachable connection, or an integral structure; it may be a mechanical connection, or an electrical connection; it may be directly connected, or indirectly connected through an intermediate medium, or may be an internal connection between two devices, elements, or components. For those of ordinary skill in the art, the specific meanings of the above terms in the present disclosure may be understood on a case-by-case basis.

In addition, the terms “first”, “second”, etc. are mainly used to distinguish different devices, elements or components (which may or may not be of the same specific types and configurations), and are not used to indicate or imply the relative importance and number of the indicated devices, elements, or components. Unless otherwise stated, “a plurality of” means two or more.

The inventor found that during the use of the battery, the internal heat of the battery could not be dissipated in time to result in the expansion of the internal hot air, so that a pressure difference is formed inside and outside the battery, and under the action of the pressure difference, the battery is prone to explosion, resulting in a safety accident. Therefore, in the related art, in order to ensure the use safety of the battery, an explosion-proof hole is generally formed in the top cover plate of the battery, and an explosion-proof sheet is arranged at the explosion-proof hole. When the pressure inside the battery reaches a threshold value, the explosion-proof sheet can automatically generate damage under excessive pressure when the pressure inside the battery reaches a threshold value, so that the inside and the outside of the battery are communicated through the explosion-proof hole and the crack of the explosion-proof sheet, so that high-temperature and high-pressure gas inside the battery is released, the internal and external pressure difference of the battery is balanced, so as to avoid the battery explosion and ensure the use safety of the battery.

However, in the actual use process, there is often a problem that the cracking accuracy of the explosion-proof sheet is not high, resulting in premature cracking of the explosion-proof sheet when the air pressure inside the battery has not yet reached the threshold value, or cracking only when the air pressure inside the battery far exceeds the threshold value, resulting in poor safety of the use of the battery. In the daily use process, the air pressure inside the battery changes along with the temperature of the environment where the battery is located, so that the explosion-proof sheet continuously deforms under the action of different pressures, so that the structure of the explosion-proof sheet is prone to aging and fragile due to multiple times of deformation. As a result, before the air pressure inside the battery reaches the threshold value, the explosion-proof sheet cannot withstand the pressure and break, thus affecting the normal service life of the battery.

Based on this, the present disclosure discloses a top cover assembly, the top cover assembly comprising: a top cover plate and an explosion-proof sheet. An explosion-proof hole is formed in the top cover plate, the explosion-proof sheet is configured for being connected to the top cover plate to close the explosion-proof hole. The explosion-proof sheet comprises a connecting portion, a body portion, a weak portion and a reinforced portion. The connecting portion is configured for being connected to the top cover plate, the body portion is connected with the connecting portion and configured for closing the explosion-proof hole, the weak portion is located between the body portion and the connecting portion, and the reinforced portion is convexly arranged on the body portion. When the pressure inside the battery reaches a threshold, the weak portion breaks, so that the body portion is at least partially separated from the connecting portion, so that a gap is generated between the body portion and the connecting portion, so that the high-temperature high-pressure gas inside the battery discharges to the outside of the battery.

By arranging the reinforced portion at the body portion, the deformation of the explosion-proof sheet under different pressure can be mitigated, that is, the deformation of the weak portion caused by the floating of the normal air pressure inside the battery during normal use of the battery can be reduced, and the aging probability of the weak portion is reduced, thereby avoiding the premature cracking of the weak portion when the internal pressure of the battery does not reach the threshold value, thereby improving the service life of the battery while ensuring the use safety of the battery. In addition, the thickness h1 of the reinforced portion and the thickness h2 of the body portion satisfy: 1<(h1+h2)/h2≤2.8, which enables the body portion to be deformed when the pressure borne by the body portion reaches the threshold to make the weak portion crack, the structure of the explosion-proof sheet is reasonable, the cracking accuracy is high, and the explosion-proof sheet is effective in improving the safety of the battery, where the cracking accuracy refers to the degree of proximity of the actual pressure to the pressure threshold when the cracking of the explosion-proof sheet occurs.

The technical solutions of the present disclosure will be further described below with reference to the embodiments and accompanying drawings.

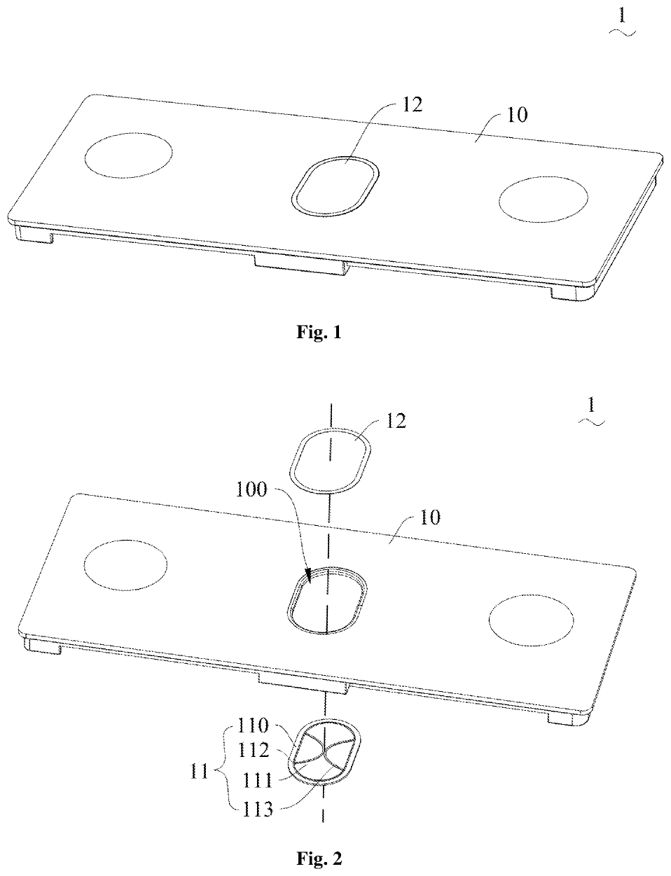

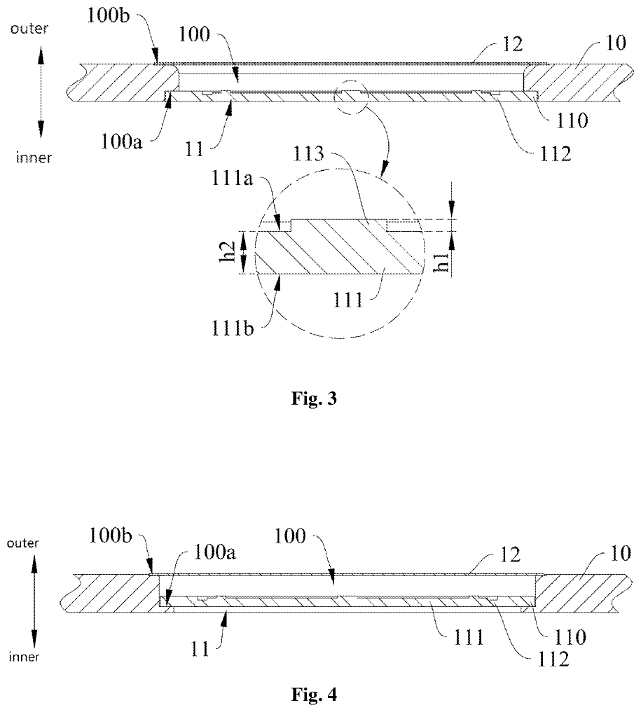

Referring to FIG. 1 to FIG. 3, FIG. 1 is a schematic structural view of a top cover assembly according to a first aspect of the present disclosure, FIG. 2 is a schematic structural exploded view of a top cover assembly according to a first aspect of the present disclosure, FIG. 3 is a partial cross-sectional view of a top cover assembly according to the first aspect of the present disclosure. The first aspect of the embodiments of the present disclosure discloses a top cover assembly 1 that can be applied to a battery, which can include a housing and an battery cell provided in the housing, and the top cover assembly 1 is connected to the housing to cover the opening of the housing. The top cover assembly 1 includes a top cover plate 10 and an explosion-proof sheet 11. The top cover plate 10 is provided with an explosion-proof hole 100 penetrating through the top cover plate 10 along its own thickness direction. The explosion-proof sheet 11 is configured for being connected to the top cover plate 10 to close the explosion-proof hole 100. The explosion-proof plate 11 comprises a connecting portion 110, a body portion 111 and a weak portion 112. The connecting portion 110 is configured for being connected to the top cover plate 10. The body portion 111 is connected to the connecting portion 110 and is configured for being disposed in the explosion-proof hole 100 to close the explosion-proof hole 100. The body portion 111 is provided with a reinforced portion 113. The weak portion 112 is located between the body portion 111 and the connecting portion 110. Along the thickness direction of the explosion-proof sheet 11, the thickness of the reinforced portion 113 is h1, the thickness of the body portion 111 is h2, and 1<(h1+h2)/h2≤2.8.

In the top cover assembly 1 of the present embodiment, the explosion-proof sheet 11 includes a weak portion 112 connected between the connecting portion 110 and the body portion 111, such that when the pressure borne by the explosion-proof sheet 11 is too large (i.e., when the air pressure in the housing exceeds a threshold value), the weak portion 112 can generate cracking, so that the process of cracking the explosion-proof sheet 11 is controllable while the high-temperature high-pressure gas in the housing of the battery is timely discharged, thereby reducing the intensity of the cracking process of the explosion-proof sheet 11, and reducing the impact of the explosion-proof sheet 11 during breakage. Meanwhile, by arranging the reinforced portion 113 on the body portion 111, the structural strength of the body portion 111 can be improved, so that the overall deformation of the body portion 111 and the reinforced portion 113 is reduced when the explosion-proof sheet 11 is subjected to external force, thereby effectively relieving the deformation effect of the explosion-proof sheet 11 under different pressure effects, and reducing the aging probability of the explosion-proof sheet 11, thereby preventing the weak portion 112 from premature cracking when the pressure borne by the weak portion 112 does not reach the threshold value, thereby prolonging the service life of the battery.

For example, the thickness h1 of the reinforced portion 113 and the thickness h2 of the body portion 111 satisfy: 1<(h1+h2)/h2≤2.8, for example, (h1+h2)/h2 is 1, 1.1, 1.2, 1.3, 1.4, 1.5, 1.6, 1.7, 1.8, 1.9, 2.0, 2.1, 2.2, 2.3, 2.4, 2.5, 2.6, 2.7 or 2.8. In this way, the reinforced portion 113 can locally thicken the body portion 111 to improve the overall structural strength of the body portion 111.

For ease of description, the side of the top cover assembly 1 for facing the inside of the battery (i.e., the side facing the inside of the housing of the battery) is defined as the inner side, and the side of the top cover assembly 1 for facing the outside of the battery (i.e., the side away from the inside of the housing) is defined as the outer side, as shown in FIG. 3, with the arrows in FIG. 3 illustrating the inner side direction as well as the outer side direction.

In some embodiments, the top cover assembly 1 further comprises an explosion-proof valve patch 12, the explosion-proof valve patch 12 is configured for being connected to the top cover plate 10 and covering the explosion-proof hole 100, along the thickness direction of the explosion-proof sheet 11, the explosion-proof valve patch 12 is located on the upper side of the explosion-proof sheet 11 and is spaced apart from the explosion-proof sheet 11. By arranging the explosion-proof valve patch 12 and the explosion-proof sheet 11 at intervals, a deformation space can be provided for the explosion-proof sheet 11, so that the explosion-proof sheet 11 is deformed to crack at the weak portion 112.

It should be noted that, since the thickness h1 of the reinforced portion 113 and the thickness h2 of the body portion 111 satisfy: 1<(h1+h2)/h2≤2.8, the overall thickness of the body portion 111 and the reinforced portion 113 is not too thick, so that sufficient space exists between the explosion-proof sheet 11 and the explosion-proof valve patch 12, so that the overall thickness of the top cover assembly 1 can be made smaller while the explosion-proof sheet 11 is deformed, so as to achieve the thin design of the top cover assembly 1.

It will be appreciated that the explosion-proof valve patch 12 described in the foregoing is located on the upper side of the explosion-proof sheet 11, which means that the explosion-proof valve patch 12 is located on a side of the explosion-proof sheet 11 facing the outside of the battery, so that the explosion-proof valve patch 12 can protect the explosion-proof sheet 11 from one side of the explosion-proof sheet 11 facing the outside of the battery, thereby avoiding the explosion of the explosion-proof sheet 11 due to accidental impact on the surface of the battery during the use of the battery, which would otherwise affect the use safety of the battery.

Referring to FIG. 3 and FIG. 4, in some embodiments, the explosion-proof hole 100 may be a step hole, the hole wall of the explosion-proof hole 100 may form a first step surface 100a, and the connecting portion 110 of the explosion-proof sheet 11 is connected to the first step surface 100a, so that the connecting position of the explosion-proof plate 11 relative to the explosion-proof hole 100 can be limited and guided by the first step surface 100a, so that the explosion-proof sheet 11 can be easily connected to a specific position of the explosion-proof hole 100 (i.e., the first step surface 100a).

Further, the hole wall of the explosion-proof hole 100 may further form a second step surface 100b spaced apart from the first step surface 100a, the second step surface 100b is located on the upper side of the first step surface 100a, and the explosion-proof valve patch 12 is connected to the second step surface 100b. The connecting position of the explosion-proof valve patch 12 relative to the explosion-proof hole 100 can be limited and guided through the second step surface 100b, so that the mounting process of the explosion-proof valve patch 12 is simpler and more convenient. At the same time, the relative position of the explosion-proof sheet 11 relative to the explosion-proof valve patch 12 can be limited by the first step surface 100a and the second step surface 100b, so that the explosion-proof sheet 11 is spaced from the explosion-proof valve patch 12. In this way, sufficient space is formed between the explosion-proof sheet 11 and the explosion-proof valve patch 12 for deformation of the explosion-proof sheet 11.

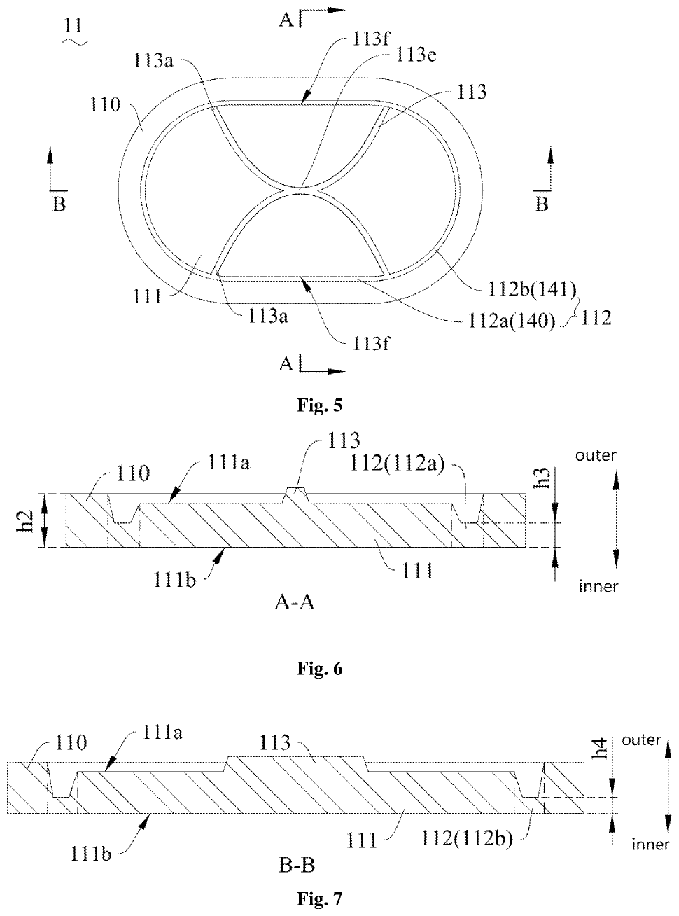

Referring to FIG. 2, FIG. 3 and FIG. 5, FIG. 5 is a schematic structural view of an explosion-proof sheet 11 according to a first aspect of the present disclosure, and in some embodiments, the connecting portion 110 may be formed as an annular sheet structure, and the connecting portion 110 may be annularly disposed on the periphery of the body portion 111. For example, the connecting portion 110 may be fixedly connected to the first step surface 100a and the side wall of the explosion-proof hole 100 in a welding manner, so that the connection between the connection part 110 and the explosion-proof hole 100 has high strength and good sealing performance.

As described above, when the interior of the battery is overheated, the weak portion 112 of the explosion-proof sheet 11 can generate cracking to discharge the high-temperature high-pressure gas inside the battery. It will be appreciated that, when the explosion-proof sheet 11 is subjected to a large external force, the weak portion 112 may first be destroyed, thereby ensuring that the cracking position of the explosion-proof sheet 11 is the weak portion 112, so that the cracking process of the explosion-proof sheet 11 is controllable, and the use safety of the explosion-proof sheet 11 is high. Therefore, the structural strength of the weak portion 112 should be less than the structural strength of the body portion 111 and the connecting portion 110. On this basis, in the inner and outer directions, the thickness of the weak portion 112 may be smaller than the thickness of the body portion 111 and the connecting portion 110, so that the structural strength of the weak portion 112 is less than the structural strength of the body portion 111 and the connecting portion 110, so that when the explosion-proof sheet 11 is subjected to a large external force, the weak portion 112 can first be damaged to generate a crack.

Referring to FIGS. 5-7, in some embodiments, the weak portion 112 may include a first portion 112a and a second portion 112b connected to each other, along a thickness direction of the explosion-proof sheet 11 (i.e., in the inner and outer directions), a minimum thickness of the first portion 112a is h3, a minimum thickness of the second portion 112b is h4, a thickness h2 of the body portion 111, a minimum thickness h3 of the first portion 112a, and a minimum thickness h4 of the second portion 112b may satisfy: h2>h3>h4 such that the structural strength of the second portion 112b is less than the structural strength of the first portion 112a, and the structural strength of the first portion 112a is less than the structural strength of the body portion 111, so that the second portion 112b is more likely to crack immediately when the pressure is greater than the threshold value, so as to further improve the cracking accuracy of the explosion-proof sheet 11, and while the second portion 112b is cracked, the body portion 111 can still be connected to the connecting portion 110 through the first portion 112a, that is, the body portion 111 may not be separated from the explosion-proof hole 100, so as to avoid the situation that the body portion 111 is completely separated from the connecting portion 110. In order to distinguish the body portion 111, the weak portion 112, and the connecting portion 110, FIG. 6 and FIG. 7 show the connections of the weak portion 112 with the body portion 111 and the connecting portion 110 respectively by dotted lines. It will be understood that the dotted lines are intended only as an indication of the position of the connections and do not constitute a limitation on the physical structure.

Further, since the thickness h3 of the first portion 112a is less than the thickness h1 of the body portion 111, that is, the structural strength of the first portion 112a is less than the structural strength of the body portion 111, the second portion 112b can be cracked when the pressure inside the battery exceeds the threshold. At the same time, the pressure inside the battery rises rapidly, causing the pressure on the explosion-proof sheet 11 to exceed the threshold instantaneously, the first portion 112a can act as a secondary cracking mechanism, that is, the first portion 112a can also be cracked to make the connection area between the body portion 111 and the connecting portion 110 smaller, or to make the body portion 111 separate from the connecting portion 110 as a whole. Therefore, the crack area for gas leakage is larger, and the gas leakage efficiency is higher, so that the inside and outside of the battery can reach a safe state of air pressure balance more quickly.

In some embodiments, there may be one or more second portions 112b and one or more first portions 112a. It will be appreciated that, as long as the number of the second portions 112b and the first portions 112a can satisfy the venting function and the safety requirement of the explosion-proof sheet 11, the number of the second portions 112b and the first portions 112a is not specifically limited in the present embodiment.

Exemplarily, the second portion 112b, there may be a plurality of first portions 112a and second portions 112b, the plurality of second portions 112b are spaced apart, the plurality of first portions 112a are respectively connected between the plurality of second portions 112b, the thickness of each of the first portions 112a may be equal, and the structural strength of each of first portions 112a may be equal, so that the overall force borne by the explosion-proof sheet 11 is more uniform, or the thickness of at least one first portion 112a is less than the thickness of the other first portions 112a, so that the structural strength of the at least one first portion 112a is less than the structural strength of the other first portions 112a, so that when the pressure inside the battery rises rapidly and the pressure borne by the explosion-proof sheet 11 is instantaneously far above a threshold, the first portions 112a can also follow the second portions 112b to start to crack from a first portion 112a with the least strength, thereby increasing the area of cracking, thereby quickly balancing the internal and external pressure difference of the housing of the battery.

Referring to FIG. 5 to FIG. 7, it will be appreciated that when the second portion 112b of the explosion-proof sheet 11 is cracked (i.e., a crack is generated between the body portion 111 and the connecting portion 110), the connecting portion 110 is still fixedly connected to the first step surface 100a of the explosion-proof hole 100, and the body portion 111 is displaced relative to the connecting portion 110, so that the body portion 111 is at least partially separated from the connecting portion 110 to generate a crack. Based on this, the weak portion 112 may be a racetrack-shaped structure, the racetrack-shaped structure may include two straight-line segments 140 and two arc-shaped segments 141, the two straight-line segments 140 are parallel to each other, and the two arc-shaped segments 141 are connected to both ends of the two straight-line segments 140 respectively, so that the two straight-line segments 140 have no shape change along the extension direction, and it is difficult to generate stress concentration, while the shape of the arc-shaped segments 141 along the extension direction changes gently, and the stress concentration can be greatly mitigated.

Further, the straight line segments 140 may be formed as the first portion 112a, and the arc-shaped segments 141 may be formed as the second portion 112b, so that when the explosion-proof sheet 1 is subjected to pressure, it is difficult to generate stress concentration at the first portion 112a, and the stress concentration at the second portion 112b can be greatly mitigated, which can reduce the situation that the second portion 112b is cracked prematurely due to excessive local stress caused by stress concentration before the pressure borne by the explosion-proof sheet 11 reaches the threshold value, which would otherwise affects the safety of the battery.

As can be seen from the foregoing, the reinforced portion 113 is configured to enhance the strength of the body portion 111 to reduce the overall deformation generated by the reinforced portion 113 and the body portion 111 when the explosion-proof sheet 11 is subjected to pressure, thereby reducing the deformation generated by the explosion-proof sheet 11 at the position of the body portion 111.

Further, the body portion 111 may include a first surface 111a and a second surface 111b opposite to each other along the thickness direction of the body portion 111 itself (i.e., along the inner and outer directions), and the first surface 111a and/or the second surface 111b are provided with the reinforced portion 113, that is, the reinforced portion 113 may be provided on the first surface 111a, or may be provided on the second surface 111b, or both the first surface 111a and the second surface 111b may be provided with the reinforced portion 113. It will be appreciated that as long as the body portion 111 can make the overall structural strength of the body portion 111 and the reinforced portion 113 meet the requirements of use, the present embodiment does not specifically limit the position of the reinforced portion 113 on the body portion 111.

Next, in this embodiment, the reinforced portion 113 is provided on the first surface 111a as an example for description.

Referring again to FIG. 3, exemplarily, the overall thickness (i.e., h1+h2) of the reinforced portion 113 and the body portion 111 may satisfy: 0.3 mm≤(h1+h2)≤1.7 mm, for example, the overall thickness (h1+h2) of the reinforced portion 113 and the body portion 111 may be 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, or 1.7 mm, etc., so that the overall structural strength of the reinforced portion 113 and the body portion 111 can satisfy that the overall deformation of the reinforced portion 113 and the body portion 111 is relatively small when the pressure borne by the explosion-proof sheet 11 does not exceed the threshold.

It will be appreciated that the structural strength of the reinforced portion 113 and the body portion 111 varies depending on the material of the explosion-proof sheet 11 when the overall thickness of the reinforced portion 113 and the body portion 111 remains the same. In order for the structural strength of the reinforced portion 113 and the body portion 111 to meet the requirements of use, and for the explosion-proof sheet 11 to be able to crack timely and quickly if the pressure to which it is subjected exceeds a threshold value, the explosion-proof sheet 11 as a whole may be made of metal, for example, the explosion-proof sheet 11 may be a thin sheet of aluminum.

Further, along the thickness direction (i.e., the inner and outer directions) of the explosion-proof sheet 11, the projection area of the body portion 111 is S1, and the projection area of the reinforced portion 113 is S2. In order to enable the reinforced portion 113 to achieve the function of improving the overall structural strength of the body portion 111, at the same time, in order to enable the body portion 111 to be greatly deformed when the pressure on the explosion-proof sheet 11 is greater than the threshold value so that the weak portion 112 can be successfully cracked, the overall structural strength of the body portion 111 should not be too large, so that the projection area S1 of the reinforced portion 113 on the body portion 111 should not be too large. Based on this, the area S1 and the area S2 may satisfy: 5≤S1/S2≤10, for example, S1/S2 may be 5.0, 5.3, 5.5, 5.7, 6.0, 6.3, 6.5, 6.7, 7.0, 7.3, 7.5, 7.7, 8.0, 8.3, 8.5, 8.7, 9.0, 9.3, 9.5, 9.7, or 10.0, etc.

It should be noted that “the projection of the body portion 111 along the inner and outer directions” refers to the projection of the body portion 111 along the inner and outer directions on a plane perpendicular to the inner and outer directions, and “the projection of the reinforced portion 113 along the inner and outer directions” refers to the projection of the reinforced portion 113 along the inner and outer directions on a plane perpendicular to the inner and outer directions.

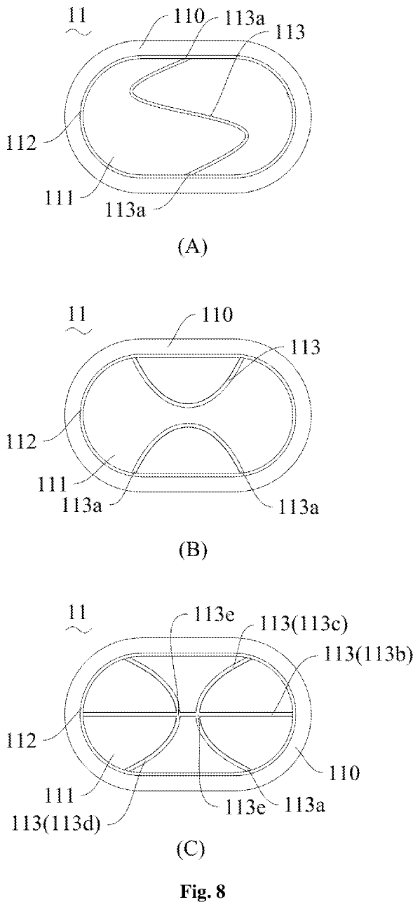

Referring to FIG. 5 and FIG. 8, in some embodiments, the reinforced portion 113 may be a convex ridge extending along one or more arc-shaped trajectories or along one or more straight line trajectories. Exemplarily, as shown in (A) of FIG. 8, the reinforced portion 113 may extend along multiple arc-shaped segments to form a wavy convex ridge. As shown in FIGS. 5 and (B) of FIG. 8, and the reinforced portion 113 may be an arc-shaped convex ridge.

In some embodiments, since the deformation of the middle portion of the body portion 111 is greatest when the explosion-proof sheet 11 is subjected to pressure, in order to make the overall deformation resistance of the body portion 111 better, the structural strength needs to be improved for the middle portion of the body portion 111. Based on this, the reinforced portion 113 can extend from the middle portion of the body portion 111 to the two sides of the body portion 111, so that the reinforced portion 113 can effectively improve the structural strength of the middle region of the body portion 111. At the same time, since the reinforced portion 113 extends from the middle portion of the body portion 111 to both sides of the body portion 111, the reinforced portion 113 can be used to disperse the force on the middle portion of the body portion 111 to both sides of the body portion 111, so that the overall force on the body portion 111 is even, and the deformation resistance of the body portion 111 is better.

In some embodiments, along the extending direction of the reinforced portion 113, the reinforced portion 113 has two end portions 113a, and the two end portions 113a may extend toward the weak portion 112, in other words, the end portions 113a of the reinforced portion 113 may extend to be close to the weak portion 112, or may extend to be connected to the weak portion 112, so that the structure of the portion of the body portion 111 adjacent to the weak portion 112 is also reinforced, so as to reduce the deformation of the portion adjacent to the weak portion 112 when the body portion 111 is subjected to external force, thereby reducing the deformation generated by the weak portion 112 to a greater extent during normal use of the battery, and further improving the anti-aging effect of the weak portion 112.

At the same time, when the internal air pressure of the battery reaches a threshold value, the body portion 111 deforms in a plurality of different directions, and since the reinforced portion 113 of the arc-shaped segment or the wavy segment may extend in a plurality of different directions, the deformation of the body portion 111 may be adapted in a plurality of different directions, thereby improving the impact resistance of the body portion 111.

Exemplarily, at least one end portion 113a of the reinforced portion 113 may extend to be connected to the weak portion 112, so that when the explosion-proof sheet 11 is subjected to an external force, the deformation generated by the weak portion 112 near the periphery of the end portion 113a is minimal, and the anti-aging effect achieved by the reinforced portion 113 on the weak portion 112 at the position is best.

As described above, the weak portion 112 may include a first portion 112a and a second portion 112b connected to each other, and the weak portion 112 may be a racetrack-shaped structure, the racetrack-shaped structure may include two straight line segments 140 and two arc-shaped segments 141, the two straight line segments 140 are formed as two first portions 112a. Optionally, at least one end portion 113a of the reinforced portion 113 may extend to be connected to the connection between the first portion 112a and the second portion 112b, or, at least one end portion 113a of the reinforced portion 113 may extend to be connected to the first portion 112a, so that the reinforcing effect of the reinforced portion 113 on the structural strength of the body portion 111 can extend to the connection between the body portion 111 and the first portion 112a, so as to further increase the structural strength gap between the first portion 112a and the second portion 112b, so that the second portion 112b is easier to quickly and timely generate cracking when the pressure borne by the explosion-proof sheet 11 exceeds a threshold value. As shown in FIG. 5, the two end portions 113a of the reinforced portion 113 respectively extend to the two connections of the first portion 112a and the second portion 112b and are connected to the first portion 112b.

Referring to FIG. 5 and FIG. 8, there may be one or more reinforced portions 113, as long as the reinforced portions 113 can be used to reinforce the overall structural strength of the body portion 111, so that the overall structural strength of the body portion 111 meets the design and use requirements, and the number of the reinforced portions 113 is not specifically limited in the present embodiment. Exemplarily, there may be a plurality of reinforced portions 113, so that the structural strength enhancement effect of the reinforced portions 113 on the body portion 111 can be improved by increasing the number of the reinforced portions 113.

As previously described, the reinforced portion 113 may be a convex ridge extending along an arc-shaped, wavy, zigzag, or straight line trajectories, and when there is a plurality of the reinforced portions, it will be appreciated that the shape of each reinforced portion 113 may be the same (as shown in FIG. 5 and in (B) of FIG. 8, as shown in FIG. 5 and in (B) of FIG. 8, where there are two reinforced portions 113, both of which are convex ridges extending along an arc-shaped trajectory), or each reinforced portion 113 may have a different shape, alternatively, some of the plurality of reinforced portions 113 may have the same shape and another part of the reinforced portions 113 may have different shapes (as shown in (C) of FIG. 5, which illustrates three reinforced portions 113, two of which are convex ridges extending along an arc-shaped trajectory and the remaining one of which is a convex ridge along a straight line trajectory), as long as the reinforced portions 113 can make the overall structural strength of the body portion 111 and the reinforced portions 113 meet the use requirements, and the extension shape of each reinforced portion 113 is not specifically limited in this embodiment.

Optionally, when there are a plurality of reinforced portions 113, at least two reinforced portions 113 are symmetrically arranged relative to the center of the body portion 111, so that the structural strength reinforcing effect of the reinforced portions 113 on the body portion 111 is more balanced, so that the force on the body portion 111 is more even, and the use stability of the body portion 111 is high.

Further, at least two adjacent reinforced portions 113 may be connected, and/or at least two adjacent reinforced portions 113 may be arranged at intervals, in other words, in the plurality of reinforced portions 113, two adjacent reinforced portions 113 are connected to each other, or the plurality of reinforced portions 113 are spaced apart from each other, or there are two adjacent reinforced portions 113 that are connected while two adjacent reinforced portions 113 are provided at intervals. As shown in FIG. 5, in an optional example, the reinforced portion 113 is two, and the two reinforced portions 113 are connected to each other. As shown in (B) of FIG. 8, in another optional example, there are two reinforced portions 113, and the two reinforced portions 113 are spaced apart. As shown in (C) of FIG. 8, in an optional example, there are three reinforced portions 113, and the three reinforced portions 113 are defined as the first reinforced portion 113b, the second reinforced portion 113c and the third reinforced portion 113d, the first reinforced portion 113b is connected to the second reinforced portion 113c and the third reinforced portion 113d, respectively, and the second reinforced portion 113c is spaced apart from the third reinforced portion 113d.

It will be appreciated that, when at least two adjacent reinforced portions 113 are connected, the two adjacent reinforced portions 113 can mutually reinforce the structural strength, thereby further improving the structural strength reinforcing effect of the reinforced portion 113 on the body portion 111.

Optionally, at least two reinforced portions 113 are connected in the middle of the reinforced portions 113 themselves to form a middle connecting portion 113e, and the middle connecting portion 113e is located in the middle of the body portion 111, so that the force borne by the middle portion of the body portion 111 can be dispersed to the multiple sides of the body portion 111 through the reinforced portion 113, so that the force on the body portion 111 is more even, and the use stability of the body portion 111 is further improved. As shown in FIG. 5, exemplarily, there are two reinforced portions 113, and the two reinforced portions 113 are convex ridges extending along the arc-shaped trajectories, for example, taking a C-shaped ridge as an example, the openings 113f of two C-shaped ridges are arranged opposite to each other, and are symmetrically arranged relative to the center of the body portion 111, and the two C-shaped ridges can be connected at the middle of the body portion 111 to form a middle connecting portion 113e. The middle connecting portion 113e at least partially covers the middle position of the body portion 111, so that the middle connecting portion 113e can effectively reinforce the middle position of the body portion 111, thereby effectively improving the deformation resistance of the body portion 111 in the middle position.

Optionally, along the thickness direction of the explosion-proof sheet 11, the projection area of the body portion 111 is S1, the projection area of the middle connecting portion 113e is S3, and the area of the middle connecting portion 113e should meet the requirement for structural strength reinforcement required for the middle position of the body portion 111, but also meet the requirement that the body portion 111 can generate large deformation when the pressure borne by the body portion 111 exceeds a threshold value, so that the weak portion 112 can deform and crack. Based on this, the area S2 and the area S3 may satisfy: 80≤S2/S3≤600, for example, the area ratio S2/S3 may be 80, 90, 100, 110, 130, 150, 170, 200, 230, 250, 270, 300, 330, 350, 370, 400, 430, 450, 470, 500, 530, 550, 570, or 600, etc.

It should be noted that “the projection of the body portion 111 along the inner and outer directions” refers to the projection of the body portion 111 along the inner and outer directions on a plane perpendicular to the inner and outer directions, and “the projection of the middle connecting portion 113e along the inner and outer directions” refers to the projection of the middle connecting portion 113e along the inner and outer directions on a plane perpendicular to the inner and outer directions.

It should also be noted that the “middle portion of the body portion 111” in the foregoing refers to a central point in the shape of the body portion 111 and a region near the center point. For example, the middle portion of the body portion 111 may refer to a region formed by extending from the center point of the body portion 111 to the edge of the body portion 111, and the projection shape of the region on the plane perpendicular to the inner and outer directions is the same as the projection shape of the body portion 111 on the plane perpendicular to the inner and outer directions, and the projection area of the region on the top cover plate 10 is S4, and S1/S4=4.

The inventors have found through research that the shape of the cross-section of the reinforced portion 113 cut by the plane perpendicular to the extending track of the reinforced portion 113 has an important influence on the structural strength of the reinforced portion 113 and the deformation resistance of the body portion 111 when the force to which it is subjected does not exceed a threshold value. Based on this, the present embodiment further defines a cross section of the reinforced portion 113, so that the deformation resistance of the body portion 111 meets the requirements.

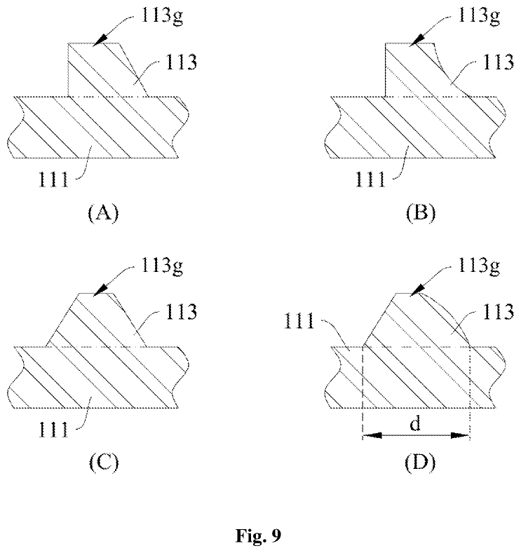

Referring to FIG. 9, FIG. 9 is a partial cross-sectional view of the explosion-proof sheet 11 according to the first aspect of the present disclosure. In some embodiments, at least one outer surface of the reinforced portion 113 is an inclined surface (i.e., a cross-sectional shape of the reinforced portion 113 is trapezoidal) or an arc surface, so that the width (i.e., the width of the cross section) of the reinforced portion 113 gradually increases from the top portion 113g of the reinforced portion 113 toward the body portion 111. Thus, compared with the case where the width of the reinforced portion 113 is constant or gradually decreases from the top portion 113g of the reinforced portion 113 toward the body portion 111, when the overall structural strength of the reinforced portion 113 and the body portion 111 is the same, the reinforced portion 113 has the smallest volume. In other words, the width of the reinforced portion 113 is gradually increased from the top portion 113g of the reinforced portion 113 toward the body portion 111, so that the reinforced portion 113 can obtain greater structural strength with a smaller volume, thereby saving the material used for the reinforced portion 113, so as to reduce the material cost of the explosion-proof sheet 11, and at the same time reduce the space occupied by the reinforced portion 113 to increase the deformation space of the explosion-proof sheet 11, so as to make the structure of the top cover assembly 1 more compact and reasonable. In order to facilitate the distinction between the body portion 111 and the reinforced portion 113, the connection between the body portion 111 and the reinforced portion 113 is shown by dotted lines in FIG. 9. It will be appreciated that, the dashed-dotted line only serves as an indication of a position of the connection, and does not constitute a limitation on the physical structure.

It will be appreciated that, when the reinforced portion 113 is provided on the side surface of the body portion 111 facing the explosion-proof valve patch 12, in the process that the body portion 111 is at least partially detached from the connecting portion 110, the reinforced portion 113 may follow the body portion 111 to move in a direction towards the outside of the battery to strike the explosion-proof valve patch 12. Since the width of the top portion 113g of the reinforced portion 113 can be smaller, the top surface area of the reinforced portion 113 can be smaller, so that when the top portion 113g of the reinforced portion 113 strikes the explosion-proof valve patch 12, the contact area between the reinforced portion 113 and the explosion-proof valve patch 12 is relatively small, and the pressure applied to the explosion-proof valve patch 12 is relatively large, so that the explosion-proof valve patch 12 is prone to being damaged or easily separated from the top cover plate 10. Therefore, the explosion-proof valve patch 12 no longer closes the explosion-proof hole 100, and the high-temperature high-pressure gas inside the battery can be discharged to the outside of the battery through the explosion-proof hole 100.

Optionally, an outer surface of the reinforced portion 113 is an inclined surface or an arc surface, as shown in (A) and (B) of FIG. 9, (A) of FIG. 9 shows that the reinforced portion 113 has an outer surface as an inclined surface, and (B) of FIG. 9 shows that the reinforced portion 113 has an outer surface as an arc surface, or two surfaces of the reinforced portion 113 are inclined surfaces (as shown in (C) of FIG. 9) or both are arc surfaces, or one surface may be an inclined surface, and the other surface is an arc surface (as shown in (D) of FIG. 9). It will be appreciated that when the two surfaces of the reinforced portion 113 are both inclined surfaces or arc surfaces, or, one surface of the reinforced portion 113 is an inclined surface, and the other surface is an arc surface, to achieve the same structural strength, the reinforced portion 113 uses the least amount of material, and the least amount of material is cost to produce the explosion-proof sheet 11.

Further, considering that it is only necessary to make the reinforcing effect of the reinforced portion 113 on the body portion 111 to meet the use requirements when the pressure borne by the explosion-proof sheet 11 is less than the threshold value, and therefore, the reinforcing effect of the reinforced portion 113 on the structural strength of the body portion 111 does not need to be too large, and the width d of one side of the reinforced portion 113 connected to the body portion 111 can satisfy: d≤0.7 mm, for example, the width d of one side of the reinforced portion 113 connected to the body portion 111 may be 0.7 mm, 0.65 mm, 0.6 mm, 0.55 mm, 0.5 mm, 0.45 mm, 0.4 mm, 0.35 mm, 0.3 mm, 0.25 mm, 0.2 mm, 0.15, or 0.1 mm.

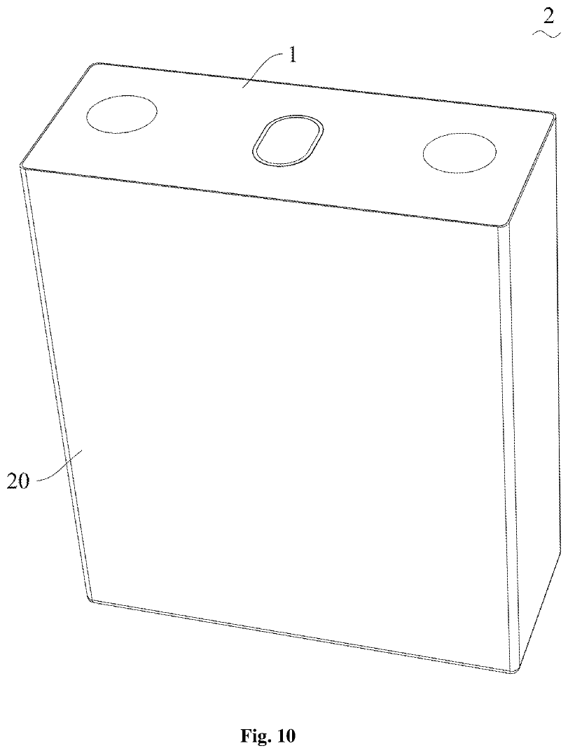

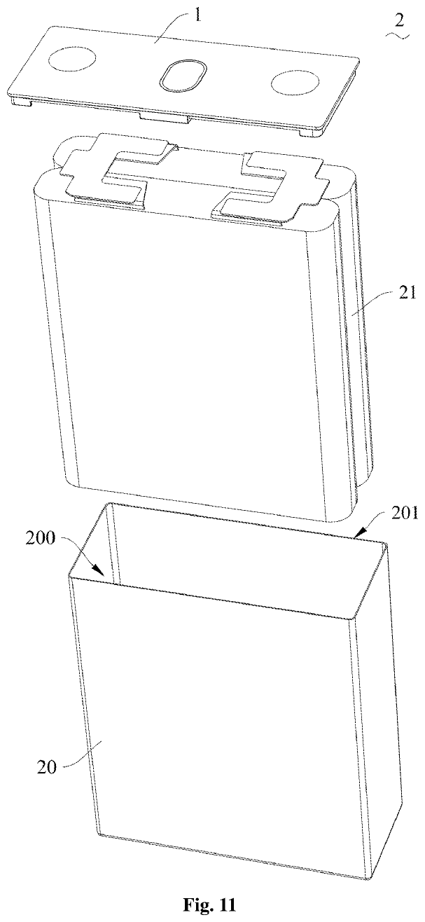

Referring to FIG. 10 and FIG. 11, FIG. 10 is a schematic structural view of a battery according to a second aspect of the present disclosure. FIG. 11 is a schematic structural exploded view of the battery according to the second aspect of the present disclosure. The second aspect of the embodiments of the present disclosure discloses a battery 2, including the top cover assembly 1 described in the first aspect above. The battery 2 may be a secondary battery. The battery 2 further includes a housing 20 and a battery cell 21. The housing 20 has an accommodating cavity 200, and the accommodating cavity 200 forms the inside of the battery described above. The housing 20 has an opening 201 communicating with an external space. The top cover assembly 1 is fixedly connected to the housing 20 and closes the opening 201, and the battery cell 21 is provided in the accommodating cavity 200.

According to the battery 2 disclosed in the second aspect of the embodiments of the present disclosure, when the internal pressure of the battery 2 reaches or exceeds a threshold value, the gas inside the battery 2 can break the explosion-proof sheet 1 and be released to the outside of the battery 2, so that the internal and external air pressure of the battery 2 is balanced, and explosion of the battery 2 is avoided. Due to the strong anti-aging capability of the explosion-proof sheet 1, the probability of premature cracking of the explosion-proof sheet 1 in the normal use process of the battery 2 is low, the service life of the battery 2 is longer, and the explosion-proof sheet 1 can generate cracking more quickly and timelier when the pressure borne by the explosion-proof sheet 1 exceeds the threshold value. Therefore, when the air pressure inside the battery 2 rises above the threshold value, the battery 2 can perform pressure relief more quickly and timelier, so as to balance the air pressure inside and outside the battery 2, and the battery 2 has high safety in use.

The top cover assembly and the battery disclosed in the embodiments of the present disclosure are described in detail above. Specific examples are used herein to describe the principles and implementations of the present disclosure, and the descriptions of the above embodiments are merely used to help understand the top cover assembly and the battery of the present disclosure and the core idea thereof. Meanwhile, for a person of ordinary skill in the art, according to the idea of the present disclosure, there is a change in the specific implementation and application range. In summary, the content of the present specification should not be construed as a limitation of the present disclosure.

What is claimed is:

1. A top cover assembly comprising:
a top cover plate, wherein an explosion-proof hole is formed in the top cover plate; and
an explosion-proof sheet, wherein the explosion-proof sheet is configured to be connected to the top cover plate to close the explosion-proof hole, and the explosion-proof sheet comprises:
a connecting portion, wherein the connecting portion is configured to be connected to the top cover plate;
a body portion, the body portion being connected to the connecting portion and being configured to be disposed in the explosion-proof hole to close the explosion-proof hole, the body portion being provided with at least one reinforced portion; and
a weak portion, the weak portion being located between the body portion and the connecting portion;
wherein along a thickness direction of the explosion-proof sheet, a thickness of the reinforced portion is h1, a thickness of the body portion is h2, and 1<(h1+h2)/h2≤2.8.

2. The top cover assembly according to claim 1, wherein 0.3 mm≤(h1+h2)≤1.7 mm.

3. The top cover assembly according to claim 1, wherein at least one outer surface of the reinforced portion is an inclined surface or an arc surface, such that the reinforced portion has a width gradually increasing from a top portion of the reinforced portion toward the body portion, a width of a side of the reinforced portion connected to the body portion is d, and d≤0.7 mm.

4. The top cover assembly according to claim 1, wherein in the thickness direction of the explosion-proof sheet, a projection area of the body portion is S1, a projection area of the reinforced portion is S2, and 5≤S1/S2≤10.

5. The top cover assembly according to claim 2, wherein in the thickness direction of the explosion-proof sheet, a projection area of the body portion is S1, a projection area of the reinforced portion is S2, and 5≤S1/S2≤10.

6. The top cover assembly according to claim 3, wherein in the thickness direction of the explosion-proof sheet, a projection area of the body portion is S1, a projection area of the reinforced portion is S2, and 5≤S1/S2≤10.

7. The top cover assembly according to claim 1, wherein the reinforced portion is a convex ridge extending along one or more arc-shaped trajectories or along one or more straight line trajectories.

8. The top cover assembly according to claim 7, wherein:
the reinforced portion is a C-shaped convex ridge;
when the body portion is provided with a plurality of the reinforced portions, at least two reinforced portions are symmetrically arranged relative to a center of the body portion, and when at least two adjacent reinforced portions are connected, the two adjacent reinforced portions are connected at their middle to form a middle connecting portion, and the middle connecting portion is located in the middle of the body portion; and
in the thickness direction of the explosion-proof sheet, a projection area of the body portion is S1, a projection area of the middle connecting portion is S3, and 80≤S1/S3≤600.

9. The top cover assembly according to claim 2, wherein the reinforced portion is a convex ridge extending along one or more arc-shaped trajectories or along one or more straight line trajectories.

10. The top cover assembly according to claim 9, wherein:
the reinforced portion is a C-shaped convex ridge;
when the body portion is provided with a plurality of the reinforced portions, at least two reinforced portions are symmetrically arranged relative to a center of the body portion, and when at least two adjacent reinforced portions are connected, the two adjacent reinforced portions are connected at their middle to form a middle connecting portion, and the middle connecting portion is located in the middle of the body portion; and
in the thickness direction of the explosion-proof sheet, a projection area of the body portion is S1, a projection area of the middle connecting portion is S3, and 80≤S1/S3≤600.

11. The top cover assembly according to claim 3, wherein the reinforced portion is a convex ridge extending along one or more arc-shaped trajectories or along one or more straight line trajectories.

12. The top cover assembly according to claim 11, wherein:
the reinforced portion is a C-shaped convex ridge;
when the body portion is provided with a plurality of the reinforced portions, at least two reinforced portions are symmetrically arranged relative to a center of the body portion, and when at least two adjacent reinforced portions are connected, the two adjacent reinforced portions are connected at their middle to form a middle connecting portion, and the middle connecting portion is located in the middle of the body portion; and
in the thickness direction of the explosion-proof sheet, a projection area of the body portion is S1, a projection area of the middle connecting portion is S3, and 80≤S1/S3≤600.

13. The top cover assembly according to claim 1, wherein in the extending direction of the reinforced portion, the reinforced portion has two end portions, and at least one end portion of the reinforced portion extends to be connected to the weak portion.

14. The top cover assembly according to claim 13, wherein:
the weak portion comprises a first portion and a second portion connected to each other, along the thickness direction of the explosion-proof sheet, a minimum thickness of the first portion is h3, a minimum thickness of the second portion is h4, and h2>h3>h4; and
at least one end portion of the reinforced portion extends to be connected to a connection of the first portion and the second portion, or at least one end portion of the reinforced portion extends to be connected to the first portion.

15. The top cover assembly according to claim 14, wherein:
the weak portion is a racetrack-shaped structure, the racetrack-shaped structure comprises two straight line segments and two arc-shaped segments, the two straight line segments are parallel to each other, and the two arc-shaped segments are respectively connected to both ends of the two straight line segments; and
the straight line segments are formed as the first portion, and the arc-shaped segments are formed as the second portion.

16. The top cover assembly according to claim 2, wherein in the extending direction of the reinforced portion, the reinforced portion has two end portions, and at least one end portion of the reinforced portion extends to be connected to the weak portion.

17. The top cover assembly according to claim 16, wherein:
the weak portion comprises a first portion and a second portion connected to each other, along the thickness direction of the explosion-proof sheet, a minimum thickness of the first portion is h3, a minimum thickness of the second portion is h4, and h2>h3>h4; and
at least one end portion of the reinforced portion extends to be connected to a connection of the first portion and the second portion, or at least one end portion of the reinforced portion extends to be connected to the first portion.

18. The top cover assembly according to claim 3, wherein in the extending direction of the reinforced portion, the reinforced portion has two end portions, and at least one end portion of the reinforced portion extends to be connected to the weak portion.

19. The top cover assembly according to claim 18, wherein:
the weak portion comprises a first portion and a second portion connected to each other, along the thickness direction of the explosion-proof sheet, a minimum thickness of the first portion is h3, a minimum thickness of the second portion is h4, and h2>h3>h4; and
at least one end portion of the reinforced portion extends to be connected to a connection of the first portion and the second portion, or at least one end portion of the reinforced portion extends to be connected to the first portion.

20. A battery comprising a housing and the top cover assembly according to claim 1, wherein the housing is provided with an accommodating cavity having an opening, and the top cover assembly is connected to the housing to cover the opening of the accommodating cavity.
